(19) United States
(12) Patent Application Publication
(10) Pub. No.: US 2023/0097662 A1
(43) Pub. Date: Mar. 30, 2023

(54) CLOUD ENVIRONMENT DELIVERY TOOL

(71) Applicant: SAP SE, Walldorf (DE)

(72) Inventors: Jesus Manuel Sanchez Martinez, Frankfurt (DE); Ryan Tolentino, Livermore, CA (US); Stephen Wilburn, Dripping Springs, TX (US)

(21) Appl. No.: 17/489,376

(22) Filed: Sep. 29, 2021

(51) Int. Cl. G06F 9/50; G06F 8/10; G06F 21/44; G06F 16/28

(52) U.S. Cl. CPC G06F 9/5072; G06F 8/10; G06F 21/44; G06F 16/288

(57) ABSTRACT

Various examples are directed to systems and methods for deploying a cloud environment to a cloud hyperscaler infrastructure. A software tool may receive a description of a cloud environment element to be included in a cloud environment. The software tool may determine that the description of the cloud environment element is consistent with cloud environment security guideline data and add the cloud environment element to cloud environment description data. A security concept document may be generated for the cloud environment. The software tool may generate deployment code comprising executable code describing the cloud environment and submit the deployment code to create the cloud environment at the cloud hyperscaler infrastructure.

### BACKGROUND

Traditionally, software has been self-contained and executed at one or more local machines making up an on-premises computing system. An enterprise desiring to use a software tool builds an on-premises computing system and executes a software application to provide the tool on that computing system. Cloud computing has disrupted this paradigm. Cloud computing allows enterprises to supplement or replace on-premises computing systems with cloud software, platforms, and even computing infrastructure provided as a service.

### BRIEF DESCRIPTION OF DRAWINGS

The present disclosure is illustrated by way of example and not limitation in the following figures.

FIG. 1 is a diagram showing one example of an environment for providing a cloud environment tool for generating and/or deploying cloud environments to one or more cloud hyperscaler infrastructure.

FIG. 2 is a flowchart showing one example of a process flow that may be executed in the environment of FIG. 1 to generate and/or modify a cloud environment description.

FIG. 3 is a flowchart showing one example of a process flow that may be executed in the environment of FIG. 1 to provide the user with access to security concept documents via one or more workspaces.

FIG. 4 is a flowchart showing one example of a process flow that may be executed in the environment of FIG. 1 to deploy a cloud environment to a cloud hyperscaler infrastructure from a security concept document.

FIG. 5 is a diagram showing one example of a screen that may be displayed to the user via the user interface of FIG. 1.

FIG. 6 is a diagram showing another example of a screen that may be displayed to the user via the user interface of FIG. 1.

FIG. 7 is a diagram showing another example of a screen that may be displayed to the user via the user interface of FIG. 1.

FIG. 8 shows an example diagram of a cloud environment.

FIG. 9 is a block diagram showing one example of a software architecture for a computing device.

FIG. 10 is a block diagram of a machine in the example form of a computer system within which instructions may be executed for causing the machine to perform any one or more of the methodologies discussed herein.

### DETAILED DESCRIPTION

In various examples, an enterprise can use a cloud hyperscaler to implement computing infrastructure. A cloud hyperscaler is a service that maintains one or more data centers comprising various computing hardware. Examples of currently available hyperscaler services include AWS from Amazon.com, Inc., Google Cloud from Google LLC., Azure from Microsoft, Inc., and Alibaba Cloud from Alibaba Group Holding Limited, among others.

Client enterprises can use hardware resources at the cloud hyperscaler data centers to execute applications and/or perform data storage that might otherwise have been performed using an on-premises computing system. In this way, the client enterprises utilize the hardware infrastructure resources of the cloud hyperscaler in place of an on-premises or other enterprise-implemented computing system.

A client enterprise uses the hyperscaler hardware to deploy and use one or more cloud environments. A cloud environment includes one or more compute elements, one or more storage elements, and/or one or more network elements that are implemented virtually at the cloud hyperscaler hardware. Users associated with a client enterprise may access the cloud environment of a client enterprise via the cloud hyperscaler.

Cloud hyperscalers may use a shared responsibility model for implementing cloud environments where the cloud hyperscaler is responsible for configuring and maintaining the physical hardware at its data centers, while the client enterprise is responsible for the configuration and management of the virtual compute elements, storage elements, and/or network elements making up the cloud environments. Accordingly, the client enterprise may be responsible for various security and other parameters of the compute elements, storage elements, and/or network elements making up a cloud environment.

One of the benefits to the client enterprise of using cloud hyperscaler-implemented cloud environments is that setting up a cloud environment may require less human labor than setting up and maintaining an on-premises computing system. An on-premises computing system implementation may draw on the expertise of different specialized technicians. For example, a data center team may manage physical hardware by racking and stacking servers. A network team may manage connectivity and network security. An operating system team may install operating systems, patches, anti-virus software and the like. An applications team may install and configure applications, and so on.

In contrast to a typical on premises computing system implementation, a cloud environment at a cloud hyperscaler can often be configured by a single user or small set of users. For example, various integrated development environments (IDEs), such as the Cloud 9 IDE, permit a single user to generate and deploy a cloud environment. Accordingly, although the cloud environment may have virtually-implemented compute elements, storage elements, and/or network elements, setting up and/or maintaining the cloud environment may be completed without subject matter specialists in each of those areas. Because of this, a cloud environment may be at higher risk of configuration errors that can lead to security vulnerabilities or other problems.

Another challenge associated with cloud hyperscaler-implemented cloud environments is related to documentation. In some examples, a security concept document is created for a cloud environment. The security concept document is a data file describing the configuration of a cloud environment including, for example, the arrangement and configuration of compute elements, storage elements, and/or network elements in a cloud environment. Security concept documents may be stored and referred to, for example, in the event of a security breach or other cloud environment failure. In many cases, however, there is no mechanism for determining whether a cloud environment's actual configuration matches that set forth in its corresponding security document or enforcing such congruence.

Various examples address these and other challenges by providing systems and methods for security deploying a cloud environment (e.g., to a cloud hyperscaler). A user may build a cloud environment by providing a cloud environment tool with elements to be included in the cloud environment and/or configurations thereof. Elements to be included in the cloud environment may include, for example, compute elements, storage elements, and/or network elements. When the user provides a description of a cloud environment element to be included in a cloud environment, the cloud environment tool may compare received description to one or more security guidelines. If the received description is consistent with the one or more security guidelines, the cloud environment tool may add it to cloud environment description data describing the cloud environment.

The cloud environment tool may utilize the cloud environment description data to generate a security concept document. The security concept document may be arranged in a human-readable text form and, in some examples, may include a diagram showing the architecture of the components of the cloud environment.

The cloud environment tool may also receive an instruction to deploy a cloud environment to a cloud hyperscaler. In response to the instruction, the cloud environment tool utilizes the security concept document and/or cloud environment description data to generate deployment code for the cloud environment. The deployment code includes instructions that can be used by a cloud hyperscaler to implement the cloud environment. The cloud environment tool may submit the deployment code to the cloud hyperscaler, which may utilize the code to implement the described cloud environment.

Providing the cloud environment tool, as described herein, may provide various benefits to the client enterprise. For example, checking the components to be configured and/or added to a cloud environment against security guidelines before modifying the cloud environment may provide a check on the user deploying a cloud environment. For example, the user may be prevented from deploying an insecure architecture even if the user him or herself is not a network security expert.

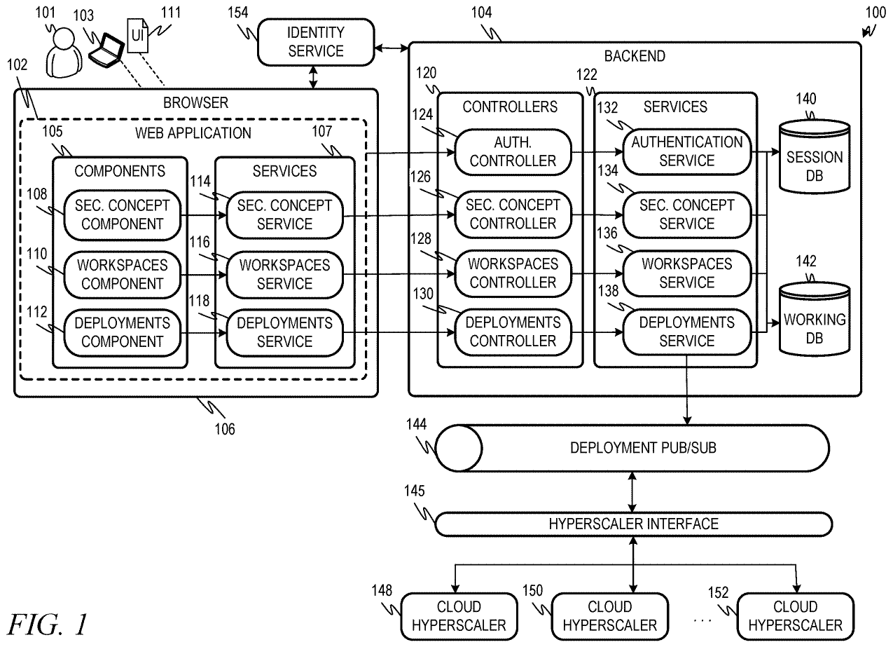

FIG. 1 is a diagram showing one example of an environment 100 for providing a cloud environment tool for generating and/or deploying cloud environments to one or more cloud hyperscaler infrastructure 148, 150, 152. The environment 100 includes a backend 104 and a web application 102. The backend 104 may be or include any suitable computing systems. In some examples, the backend 104 is implemented at a cloud environment hosted by a cloud hyperscaler.

The web application 102 executes at a user computing device 103 of a user 101. The user computing device 103 may be any suitable computing device such as, for example, a mobile computing device, a laptop computing device, a desktop computing device, and the like. The web application 102 may execute in a web browser 106 of a user computing device 103. The user 101, for example, may be an administrative user or other user of a client enterprise with responsibility for generating, verifying, deploying, or otherwise administering a cloud environment at one or more of the cloud hyperscaler infrastructure 148, 150, 152. The web application 102 may provide a user interface 111, described in more detail herein, that provides the user 101 with access to the cloud environment tool.

The cloud environment tool arrangement shown at the environment 100 may provide various sub-tools to the user 101. The sub-tools provide functionality of the cloud environment tool to the user 101 and, in some examples, to other users not shown in FIG. 1. A security concept sub-tool generates security concept documents describing deployed and/or un-deployed cloud environments. For example, the security concept sub-tool may receive one or more cloud environment element descriptions. A cloud environment description may describe a new cloud environment element to be added to a cloud environment and/or may describe a revised configuration for a cloud environment element that is already part of the cloud environment. The security concept sub-tool may apply one or more security guidelines to the cloud environment element description and, if the security guidelines are met, generate and/or update a security concept document for the cloud environment.

The workspaces sub-tool may permit the user 101 to collaborate with other users to generate and/or modify security concept documents describing cloud environments. For example, one user 101 may provide various cloud environment element description data to generate a security concept document and then upload the security concept document to a workspace. The workspace may permit other users who are also members of the workspace to access the security concept document, modify the security concept document, and/or use the security concept document to deploy the cloud environment.

Also, in some examples, the workspaces sub-tool may permit the user 101 to access, modify, and/or deploy security concepts generated by other users that have been uploaded to a workspace of which the user 101 is a member. In this way, a single user 101 may generate a security concept document for a cloud environment and then provide the security concept document to one or more other users for review.

A deployment sub-tool may deploy a cloud environment to one or more cloud hyperscaler infrastructure 148, 150, 152. For example, the deployment sub-tool may utilize a security concept document to generate deployment code for deploying the cloud environment described by the security concept document. The deployment code includes instructions that can be used by a cloud hyperscaler infrastructure 148, 150, 152 to implement the cloud environment described by the security concept document. In some examples, representing a cloud environment including one or more cloud environment elements as code may be referred to as Infrastructure as Code (IaC). The deployment code may include a series of commands that can be provided to a cloud hyperscaler infrastructure 148, 150, 152 to cause the cloud hyperscaler infrastructure 148, 150, 152 to implement a cloud environment and/or update an existing cloud environment to conform with the security concept document. The deployment sub-tool may provide the deployment code to one or more of the hyperscaler infrastructure 148, 150, 152 via the deployment pub/sub tool 144 and hyperscaler interface 145, as described herein.

In the example of FIG. 1, the security component sub-tool, workspaces sub-tool, and deployment sub-tool are implemented using components 105 and services 107 at the web application 102 as well as controllers 120 and services 122 at a backend 104. For example, the security concept sub-tool may be implemented using a security concept component 108 and security concept service 114 at the web application 102 as well as a security concept controller 126 and security concept service 134 at the backend 104. The workspaces sub-tool may be implemented with a workspaces component 110 and workspaces service 116 at the web application 102 as well as a workspaces controller 128 and workspaces service 136 at the backend 104. The deployment sub-tool may be executed using a deployments component 112 and deployments service 118 at the web application 102 as well as a deployments controller 130 and deployments service 138 at the backend 104.

In various examples, the components 105 at the web application 102 provide the user interface 111 and various sub-tool logic to the user 101. Services 107 facilitate communication between the components 105 and the backend 104. At the backend 104, the controllers 120 and services 122 may be implemented according to a model-view-controller (MVC) arrangement. For example, controllers 120 may handle communications with the web application 102, acting as an interface between the components of the web application 102 and the services 122. The services 122 may perform functionality of the cloud environment tool and various sub-tools such as, for example, applying security guidelines, generating security concept documents, generating deployment code, submitting the deployment code to the cloud hyperscaler infrastructure 148, 150, 152, etc. It will be appreciated, however, that FIG. 1 shows just one example architecture for implementing the cloud environment tool described herein and that alternate architectures may be used.

The backend 104 may also include one or more databases such as, for example, a working database 142 and a session database 140. The working database 142 may store data associated with providing the cloud environment tool. For example, the working database 142 may store cloud environment description data and/or security concept documents created by the security concept sub-tool. In some examples, the working database 142 may also store cloud environment security guideline data or other data describing rules or standards for cloud environments. In some examples, the working database 142 stores deployment code generated by the deployment sub-tool, version data and/or other metadata about security concept documents and/or cloud environment description data. The working database 142 may be any suitable type of database such as, for example, a Postgre SQL database.

The session database 140 may include data about a user's 101 individual sessions with the cloud environment tool. For example, as described herein, the backend 104, in some examples, is implemented at a cloud environment that was previously deployed to a cloud hyperscaler, which may be one of the cloud hyperscaler infrastructure 148, 150, 152 or a different cloud hyperscaler. Because of this, in some examples, different communications between the web application 102 and backend 104 may actually be handled by different servers at the cloud hyperscaler. The session database 140 stores state data about the user's 101 session, allowing different servers or other hyperscaler hardware to respond to handle different parts of the session. In some examples, the session database 140 is or includes an in-memory database such as, for example, a Redis cloud database available from Redis, Inc. of Mountainview, Calif.

The deployment sub-tool may utilize the deployment publication/subscription (pub/sub) message queue 144 and hyperscaler interface 145 to communicate with cloud hyperscaler infrastructure 148, 150, 152. The hyperscaler interface 145 may be configured to implement cloud environments at one or more of the hyperscalers 148, 150, 152. For example, the hyperscaler interface 145 may be configured to use deployment code generated by the deployment sub-tool to implement a cloud environment described by the deployment code.

In some examples, the deployment hyperscaler interface 145 implements the deployment to the cloud environment using the Terraform IaC tool from HashiCorp. For example, the deployment hyperscaler interface 145 may correspond with the cloud hyperscaler infrastructure 148, 150, 152 to determine whether the cloud environment to be deployed is already running and, if so, what is its state. If the cloud environment is already running, the deployment hyperscaler interface 145 may reconcile the running cloud environment with what is indicated by the deployment code. The deployment hyperscaler interface 145 may generate a plan to execute against the running version of the cloud environment to make it consistent with the deployment code and send specific commands for execution at the cloud hyperscaler infrastructure 148, 150, 152. The deployment hyperscaler interface 145 may send commands (e.g., commands selected from the deployment code) to the cloud hyperscaler infrastructure 148, 150, 152 to execute the plan.

The pub/sub message queue 144 may be used to allow the deployment sub-tool (e.g., the deployments service 138) to initiate deployment of a cloud environment to a cloud hyperscaler infrastructure 148, 150, 152 without the need to maintain a continuous connection, such as a Hypertext Transfer Protocol (HTTP) connection, with the hyperscaler interface 145 and/or a cloud hyperscaler infrastructure 148, 150, 152 for the duration of the deployment. For example, it may take the hyperscaler interface 145 a considerable amount of time (e.g., 5 or more minutes) to complete a cloud environment deployment at a hyperscale infrastructure 148, 150, 152. Instead of maintaining an HTTP or other connection for that time, the deployment sub-tool (e.g., the deployments service 138) may publish a message to the deployment pub/sub message queue 144. The message may include deployment code for deploying the cloud environment. The deployment sub-tool (e.g., the deployments service 138) may also subscribe to receive responses to the message from the hyperscaler interface 145.

When the deployment pub/sub message queue 144 receives, from the deployment sub-tool, a message requesting initiation of a cloud environment, it may publish the message to the hyperscaler interface 145, which may begin to deploy the cloud environment according to the deployment code. The deployment pub/sub message queue 144 may also listen for replies to the message from the hyperscaler interface 145. Replies from the hyperscaler interface 145 may indicate the status of the requested cloud environment deployment and may include, for example, a completion notice, error notice or other reply message. When a reply message is received, the deployment pub/sub message queue 144 provides the result to the deployment sub-tool (e.g., the deployments service 138 thereof), which may record that the deployment is complete and/or take another appropriate action if the deployment is not complete.

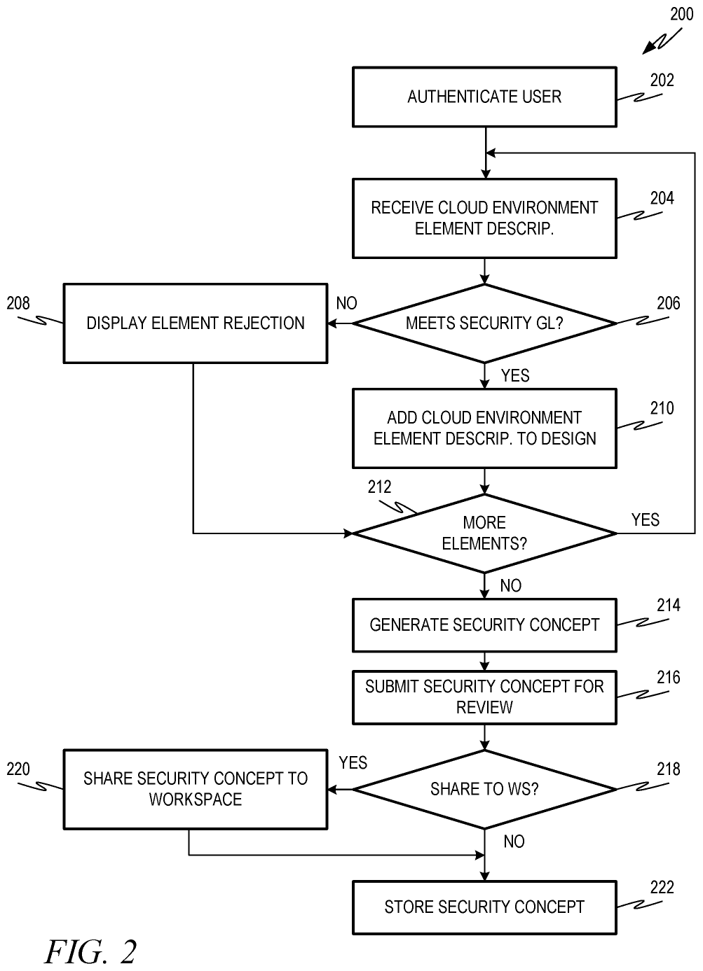

FIG. 2 is a flowchart showing one example of a process flow 200 that may be executed in the environment 100 of FIG. 1 to generate and/or modify a cloud environment description. At operation 202, the user 101 is authenticated. For example, the user 101 may access the web application 102 by accessing a Universal Resource Locator (URL) or other address using the browser 106. This may prompt the browser 106 to download and/or begin executing the web application 102. The web application 102 may invite the user 101 to authenticate before the user 101 is provided with access to the functionality of the cloud environment tool.

Authentication may be performed in any suitable manner. For example, the browser 106 may be in communication with an identity service 154. The identity service 154 may, through the browser 106, prompt the user 101 to provide authentication information such as, for example, a user name, password, personal identification number (PIN) and/or the like. In some examples, the identity service 154 prompts the user 101 to provide multi-factor authentication. Provided that the user 101 is properly authenticated, the identity service 154 reports the identity of the user 101 to the backend 104 (e.g., to an authentication controller 124 and authentication service 132). The authentication controller 124 may handle communication with the web application 102 and identity service 154. The authentication service 132 may open a session for the user 101, which may include creating a session record for the user 101 at the session database 140. Subsequent communications with the user 101 via the web application 102 may be associated with the session.

At operation 204, the cloud environment tool (e.g., the security concept sub-tool thereof) may receive a description of a cloud environment element to be included in a cloud environment. The cloud environment element may be a compute element, a storage element, and/or a network element. The description of the cloud environment element received at operation 204 may be a description of a new cloud environment element to be added to the cloud environment and/or a modification to an existing cloud environment element. The description may identify the cloud environment element and/or may include various other parameters for the cloud environment element such as, for example, connectivity to other elements, security parameters, and the like.

At operation 206, the security concept sub-tool (e.g., the security concept service 134) may compare the cloud environment element description received at operation 204 to security guideline data. The security guideline data describes one or more security guidelines for the cloud environment. The security guidelines may describe the cloud environment element, the relationship between the cloud environment element and other elements, one or more configuration parameters for the cloud environment element, and the like. One example security guideline may indicate a list of ports of the cloud environment element that should not be open. The cloud environment element description may fail to meet such a guideline if it indicates that one of the forbidden ports is to be open. Another example security guideline may indicate a storage bucket or other portion of a persistence at the cloud environment that should be encrypted and the location of an encryption key for the storage bucket. The cloud environment element description may fail to meet such a guideline if it fails to encrypt the storage bucket or fails to store the encryption key for the storage bucket in the way set forth by the security guideline.

Yet another example security guideline may indicate that logging should be activated for each storage bucket or other portion of a persistence at the cloud environment. The cloud environment description may fail to meet such a guideline if it fails to activate the indicated logging functionality. Another example security guideline may indicate that some or all of the elements of the cloud environment should not be reachable from the Internet. A cloud environment element description may fail to meet such a guideline, for example, if the described cloud environment element is or would be reachable from the Internet when the security guideline indicates that it should not be.

If the cloud environment element description fails to meet the security guidelines, the security concept sub-tool may provide the user 101 with a rejection message. The rejection message may include an indication that the provided cloud environment element description did not meet security guidelines. In some examples, the rejection message may also include a description of the reason that the cloud environment element description failed to meet the guidelines, for example, to assist the user 101 in correcting the cloud environment element description. To send the rejection message, for example, the security concept service 134 may send data describing the rejection message to the security concept controller 126. The security concept controller 126 may provide the rejection message to the web application 102 via the security concept service 114. The security concept service 114 may pass the message to the security concept component 108, which may render the rejection message at a screen of the user computing device 103 for viewing by the user 101.

If the cloud environment element description meets the security guidelines, the security concept sub-tool may, at operation 210 add the cloud environment element to the existing cloud environment description data stored at the working database 142 and/or modify the cloud environment description data to reflect the cloud environment element description.

At operation 212, after modifying the cloud environment description at operation 210 and/or displaying the design element rejection message at operation 208, the security concept sub-tool (e.g., the security concept service 134) may determine if there are additional cloud environment elements to be added and/or modified at the cloud environment. For example, the user 101 may be queried to indicate whether the user 101 has any additional cloud environment elements or modifications thereto to provide. If there are additional cloud environment elements or modifications to cloud environment elements, the security concept sub-tool returns to operation 204 to receive a cloud environment element description from the user 101.

If no additional cloud environment elements or modifications are determined at operation 212, the security concept sub-tool (e.g., the security concept service 134) generates a security concept document from the cloud environment description data at operation 214. This may include, for example, creating a human-readable text version of the cloud environment description data. Generating the security concept document may also, in some examples, include generating a cloud environment diagram showing some or all of the cloud environment elements of the cloud environment. In some examples, instead of creating the security concept document at operation 216, the cloud environment description data may be maintained in the format of a security concept document at operation 210.

At operation 216, the security concept sub-tool (e.g., the security concept service 134) may submit the security concept document for security review. The review may be automated and/or conducted by a human user. In some examples, submitting the security concept document for review includes sharing the security concept document to a workspace, as described herein.

At operation 218, the security concept sub-tool and/or the workspace sub-tool (e.g., the security concept service 134 and/or the workspaces service 136) determines whether the security concept document is to be shared to a workspace. For example, the user 101 may be queried via the web application 102 to provide an indication of whether the security concept document for the cloud environment should be shared to a workspace and, if so, to which workspace or workspaces it should be shared. In some examples, as described herein, the security concept document is shared to a workspace that is accessible by one or more other users who are reviewers and provide the review described herein above with respect to operation 216.

If the security concept document is to be shared to one or more workspaces, the workspace sub-tool (e.g., the workspace service 136) shares the security concept document to the indicated workspace or workspaces at operation 220. This may include, for example writing the security document to the working database 142 at a location or locations associated with the relevant workspace or workspaces. In another example, sharing the security concept document to the indicated workspace or workspaces includes writing an indicator of the workspace or workspaces to a record at the working database 142 that stores the security concept document. At operation 222, the security concept document may be stored to the working database 142, for example, including an indicator of one or more workspaces to which the security concept document will be shared, as described herein, if the security document is to be shared to one or more workspaces.

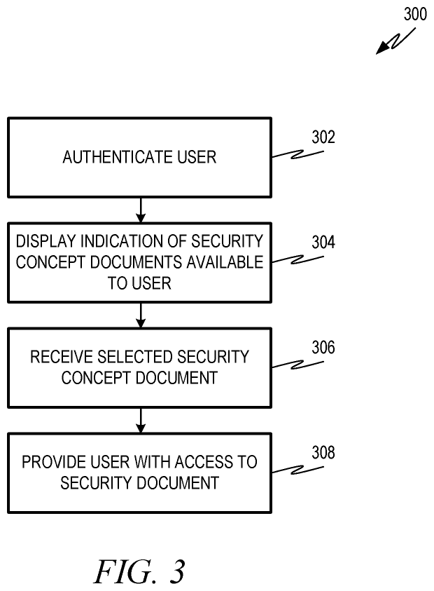

FIG. 3 is a flowchart showing one example of a process flow 300 that may be executed in the environment 100 of FIG. 1 to provide the user 101 with access to security concept documents via one or more workspaces. At operation 302, the cloud environment tool may authenticate the user 101, for example, in a manner similar to that described with respect to operation 202 of the process flow 200.

At operation 304, the workspace sub-tool displays to the user 101 an indication of security concept documents that are available to the user 101. For example, the workspaces service 136 may maintain a list of users and of workspaces that are associated with those users. The list may be stored, for example, at the working database 142 as a table or other suitable data structure. The workspace sub-tool (e.g., the workspaces service 136) may identify security documents associated with each of the workspaces associated with the user 101. An indication of the identified security documents may be provided to the workspaces controller 128. The workspaces controller 128 may communicate the identified workspaces to the workspaces service 116, which may provide the same to the workspaces component 110. The workspaces component 110 may generate a screen of the user interface 111 or otherwise modify the user interface 111 to display indications of the security concept documents.

At operation 306, the workspaces sub-tool receives an indication of a security concept document from the security concept documents determined at operation 304. For example, the user 101 may select a security concept document from the user interface 111. At operation 308, the workspaces sub-tool provides the user 101 with access to the selected security concept. For example, the user 101 may utilize the security concept sub-tool to modify the security concept document, for example, as described with respect to FIG. 2. Also, in some examples, the user 101 may utilize the deployment sub-tool, as described herein, to deploy the cloud environment described by the security concept document to a cloud hyperscaler infrastructure 148, 150, 152.

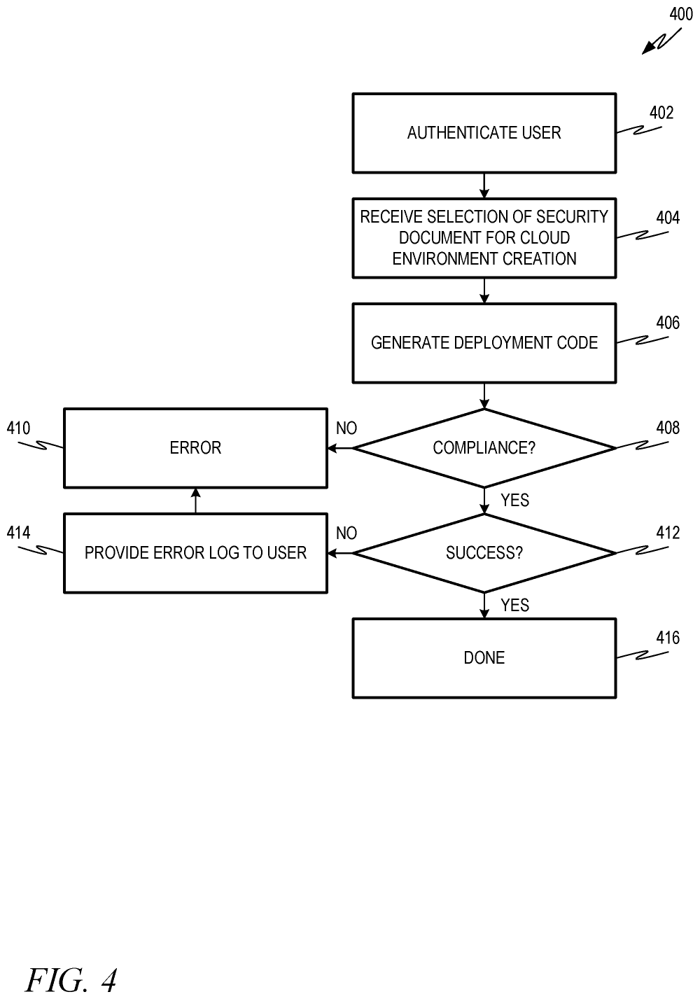

FIG. 4 is a flowchart showing one example of a process flow 400 that may be executed in the environment 100 of FIG. 1 to deploy a cloud environment to a cloud hyperscaler infrastructure 148, 150, 152 from a security concept document. At operation 402, the user 101 may be authenticated, for example, as described herein with respect to operation 202 of the process flow 200.

At operation 404, the deployment sub-tool receives an indication of a security concept document that will be the basis of the cloud environment to be deployed. For example, the user 101 may be provided with a screen of the user interface 111 that includes an indication of security concept documents that can be used to deploy cloud environments. The user 101 may make a selection of a security concept through the web application 102. The selection may be provided to the deployments component 112, which may use the deployments service 118 to communicate the selected security component to the backend 104. At the backend 104, the deployments controller 130 provides the selected security concept document to the deployments service 138.

In some examples, the user 101 may be permitted to select on security concept documents that have been approved for deployment. For example, as described herein with respect to operation 216, upon completion of security concept document describing a cloud environment, the security concept document may be submitted for review, for example, to an automated review and/or to another user or user group. In some examples, the screen of the user interface 111 from which the user selects security concept documents may only list security concept documents that have been approved for deployment. In other examples, the deployments sub-tool may perform a check to determine whether a user-selected security concept document has been approved for deployment. If the selected security concept document has not been approved for deployment, the user may not be permitted to proceed.

At operation 406, the deployment sub-tool (e.g., the deployments service 138) may generate deployment code for the cloud environment. At operation 408, the deployment sub-tool (e.g., the deployments service 138) determines if the deployment code is validated. This may include, for example, comparing the deployment code to one or more validation rules. If the deployment code fails to meet one or more of the validation rules, the deployment sub-tool (e.g., the deployments service 138) may initiate an error at operation 410. If the deployment code is compliant, the deployment sub-tool (e.g., the deployments service 138) requests deployment to the cloud hyperscaler infrastructure 148, 150, 152. This may be performed in any suitable manner. For example, the deployments service 138 may publish a message including the deployment code to the deployment pub/sub message queue 144, which may provide the message to the hyperscaler interface 145, which may initiate deployment of the cloud environment. The deployments service 138 may also subscribe to reply messages from the hyperscaler infrastructure 145 referencing the deployment.

At operation 412, the deployments sub-tool (e.g., the deployments service 138) may determine whether the deployment was a success. For example, the deployment pub/sub message queue 144 may listen for messages from the hyperscaler interface 145 indicating whether the deployment was successful. The deployment service 138 may subscribe to messages related to its requested deployment. The deployment pub/sub message queue 144 may provide the subscribed to messages from the hyperscaler interface 145 to the deployments service 138, which may determine whether the deployment was successful. If the deployment is not successful, the deployment sub-tool (e.g., the deployments service 138) may provide an error log to the user 101 at operation 414, for example, via the web application 102. The error log may indicate the reasons that the deployment was not successful. For example, the error log may include and/or include information from subscribed to messages received from the cloud hyperscaler infrastructure 148, 150, 152. If the deployment is successful, the process flow 400 may be complete at operation 416.

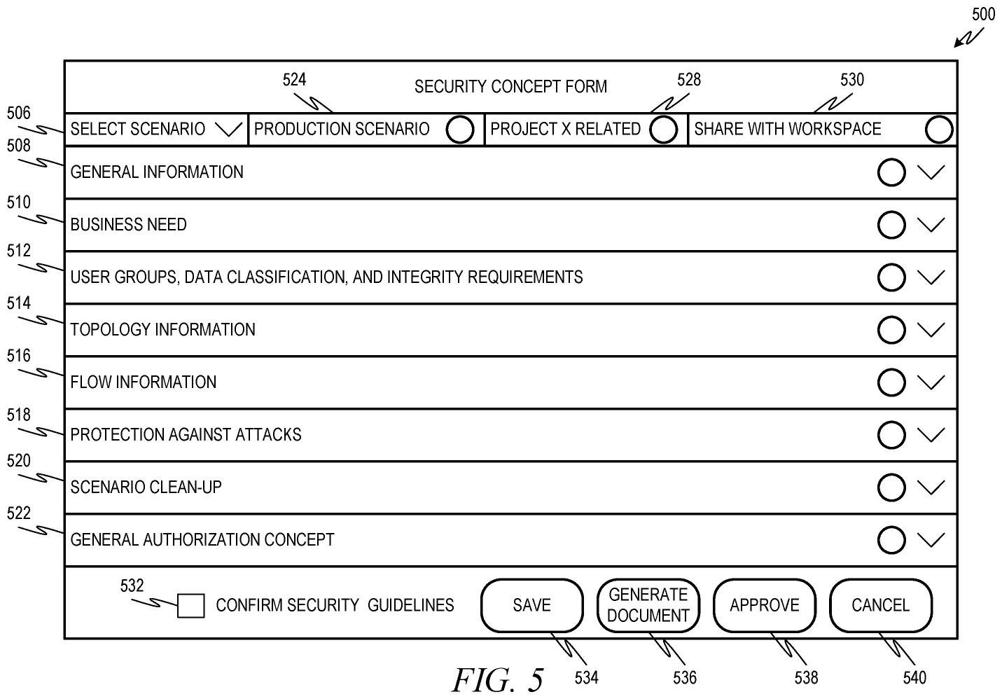

FIG. 5 is a diagram showing one example of a screen 500 that may be displayed to the user 101 via the user interface 111 of FIG. 1. The screen 500 is for receiving cloud environment description data describing a cloud environment. The cloud environment description data received via the screen 500 may be used to generate a security concept document, as described herein.

The screen 500 includes various fields where the user 101 can provide cloud environment element descriptions. A scenario row 506 provides fields where the user 101 can provide information about scenarios for the cloud environment. For example, a field 524, when selected, may indicate that the cloud environment is to be for a production scenario. A field 528, when selected, may indicate that the cloud environment is associated with a particular project. A workspace field 530, when selected, may indicate that the security concept document for the cloud environment is to be shared to a workspace. For example, when the user 101 selects the field 530, the user 101 may be further prompted to indicate the workspace or workspaces to which the security concept document is to be shared.

The rows 508, 510, 512, 514, 516, 518, 520, 522 include additional categories of information that may be provided as cloud environment element description. In some examples, the rows 508, 510, 512, 514, 516, 518, 520, 522 can be expanded to display additional fields for receiving information about the respective categories. A general information row 508 may be for receiving general cloud environment element description data about the cloud environment. A business need row 510 may be for receiving cloud environment element description data about the business need for the cloud environment, such as, for example, which products, clients, customers, and the like will be supported from the cloud environment. A user groups, data classification, and integrity requirements row 512 may be for receiving cloud environment element description data about, for example, user groups that are permitted to access the cloud environment such as, for example, the identity of the users/user groups, privileges of different users/user groups and the like. The row 512 may also be for receiving information about the types of data that will be stored at the cloud environment and, in some examples, also includes one or more integrity requirements describing how the data will be stored.

A topology information row 514 may be for receiving cloud environment element description about the topology of the cloud environment including, for example, cloud environment elements to be included in the cloud environments, connectivity, and other interactions between the elements, etc. A flow row 516 may be for receiving cloud environment element description about data flows in the cloud environment. A protection against attacks row 518 may include information about security settings at the cloud environment. A scenario clean-up row 520 may be for receiving cloud environment element description data about how to wind-down the cloud environment when it is destroyed. A general authorization concept row 522 may be for receiving approval of the security concept document. For example, the general authorization concept row 522 may be filled out by an administrative user or other user with privileges to approve security concept documents and/or associated cloud environments.

The screen 500 also includes a field 532 that may be checked by the user 101 to indicate that the user 101 has complied with security guidelines. In some examples, the field 532 may be checked automatically after the security concept is evaluated against security guidelines as described herein. A save button 534 may be selected to save the cloud environment description data entered via the screen 500. A generate document button 536 may be selected by the user 101 to prompt the generation of a security concept document from the cloud environment description data entered at the screen 500. An approve button 538 may be selected, for example, by an administrative user, to approve the security concept document and/or cloud environment description data included at the screen 500. A cancel button 540 may be selected to close the screen 500.

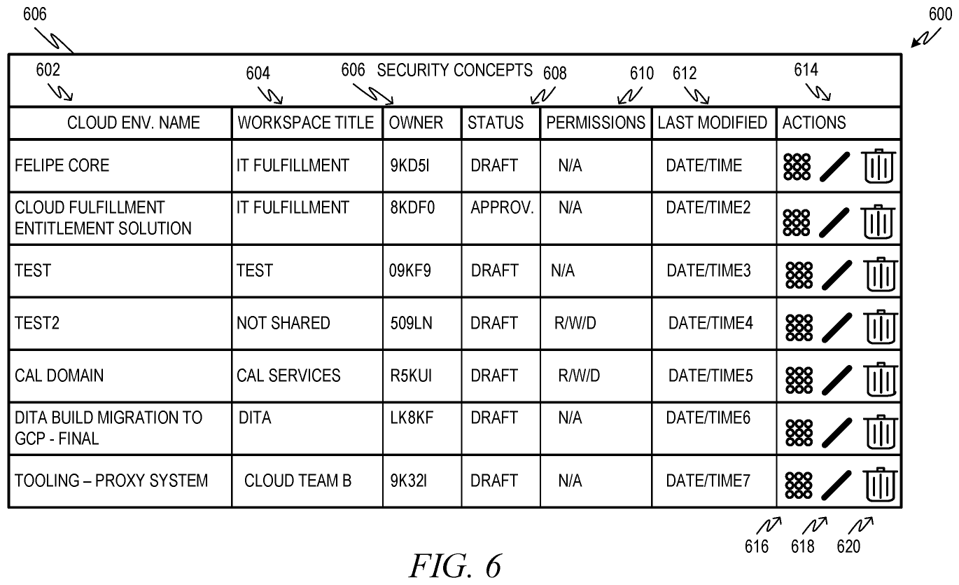

FIG. 6 is a diagram showing one example of a screen 600 that may be displayed to the user 101 via the user interface 111 of FIG. 1. The screen 600, for example, shows different cloud environments/security concept documents that can be selected for actions. In some examples, the screen 600 is generated by the workspaces sub-tool to provide the user 101 with an indication of different cloud environments and/or security concept documents that the user 101 has authority to act on. In the screen 600, different cloud environments/security concept documents are indicated by columns. The columns 602, 604, 606, 608, 610, 612 indicate information about the respective cloud environments/security concept documents. A column 602 includes the name of the cloud environments/security concept documents. A workspace title column 604 indicates a workspace to which the cloud environments/security concept documents have been shared. For example, the screen 600 may only show cloud environments/security concept documents that are part of workspaces that are accessible by the user 101. An owner column 606 may include an indication of an owner of the respective cloud environments/security concept documents. The owner may be a user, user group, or the like.

A status column 608 may indicate the status of the respective cloud environments/security concept documents. For example, the status column 608 may indicate whether the cloud environments/security concept documents are in draft form and/or have been approved for deployment. A permissions column 610 indicates the permissions that the user 101 has relative to the cloud environments/security concept documents. For example, the column 610 may indicate whether the user 101 has rights to read, write, and/or deploy the respective cloud environments/security concept documents. An N/A permission may indicate that the user cannot read, write, or deploy the cloud environments/security concept documents. A column 612 indicates the date and time of the last time that the respective cloud environments/security concept documents were modified.

An actions column 614 may include icons that, when selected, begin the indicated actions on the respective cloud environments/security concept documents. For example, icons 616 may be selected to deploy the respective cloud environments/security concept documents. Icons 618 may be selected to write to or otherwise modify the respective cloud environments/security concept documents. Icons 620 may be selected to delete the respective cloud environments/security concept documents.

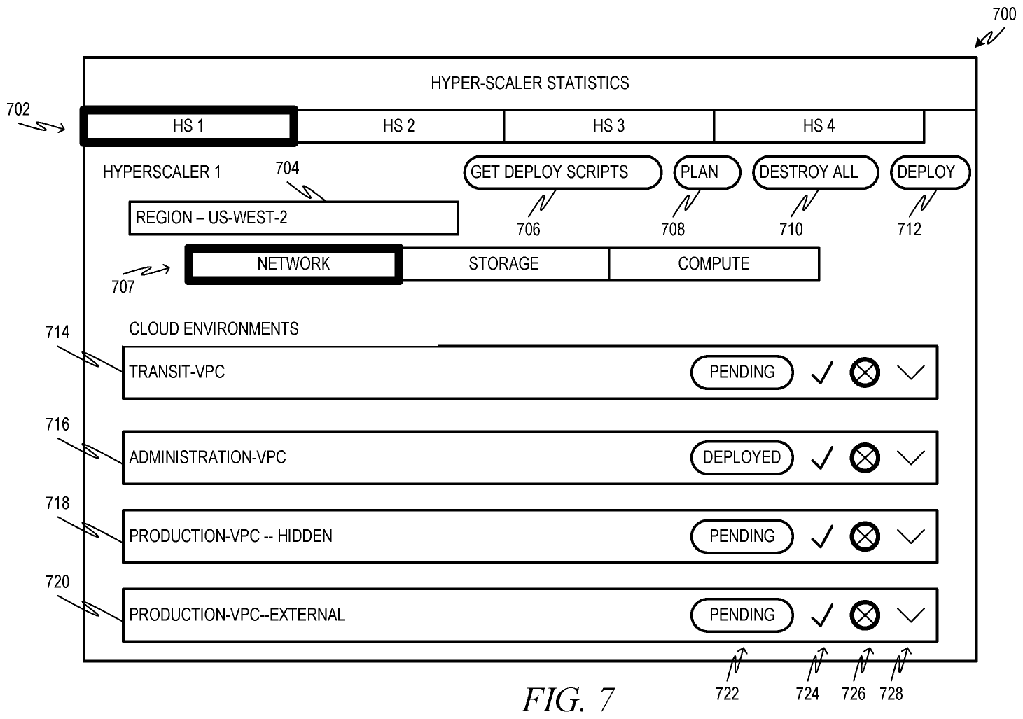

FIG. 7 is a diagram showing one example of a screen 700 that may be displayed to the user 101 via the user interface 111 of FIG. 1. The screen 700 shows hyperscaler statistics including, for example, cloud environments deployed by the user 101 or the client enterprise associated with the user 101. The screen 700 may be displayed to the user 101, for example, as part of the deployment sub-tool and/or as part of the workspaces sub-tool. For example, the screen 700 shows four example cloud environment fields 714, 716, 718, 720. The fields 714, 716, 718, 720 list the name and status of the four example cloud environments. The cloud environments corresponding to the fields 714, 716, 718, 720 may be cloud environment and/or associated security concept documents that are part of a workspace or workspaces of which the user 101 is a part.

The fields 714, 716, 718, 720 may also provide information about the respective cloud environments and/or facilitate actions. For example, icons such as icon 722 may indicate the status of the respective cloud environments such as, for example, deployed or pending. Icons such as icon 724 may indicate that a cloud environment and/or security concept document has been approved. A button, such as the button 726, may be selected to delete a cloud environment and/or security concept document. Drop down buttons, such as the drop down button 728, may be selected to expand the respective fields 714, 716, 718, 720 to provide more information about the respective cloud environments and/or security concept documents.

The screen 700 has a row 702 from which the user 101 may select a cloud hyperscaler infrastructure 148, 150, 152, etc. to view. In the example of FIG. 7, a cloud hyperscaler called HS1 is selected such that the cloud environments indicated by fields 714, 716, 718, 720 may be deployed to or intended to be deployed to the cloud hyperscaler HS1. The user 101 may view cloud environments and/or security concepts associated with other cloud hyperscaler infrastructure 148, 150, 152 by selecting other fields from the row 702.

In the example of FIG. 7, a hyperscaler region field 704 is for the user 101 to select a region of the selected cloud hyperscaler infrastructure 148, 150, 152. For example, as shown, a region called US-WEST-2 is selected. Accordingly, the cloud environments indicated by fields 714, 716, 718, 720 may be deployed or intended to be deployed to the cloud hyperscaler HS1 at the region called US-WEST-2.

The screen 700 also includes an element type field 707 from which the user 101 may select a type of cloud environment element such as, for example, a network element, or a compute element. The user may select a type of cloud environment element from the field 706, for example, to limit the cloud environments indicated by fields 714, 716, 718, 720 to cloud environments containing primarily the selected elements.

The screen 700 also includes buttons 706, 708, 710, 712. The button 706 may be selected to prompt the deployment sub-tool to generate deployment code or scrips for a selected cloud environment. For example, the user 101 may select one of the fields 714, 716, 718, 720 to indicate a cloud environment and then select the button 706 to prompt generating of the deployment code. A plan button 708 may be selected to prompt the deployment sub-tool to create a deployment plan for a selected cloud environment. A destroy all button 710 may be selected to prompt the deployment sub-tool to destroy all of the cloud environments listed at fields 714, 716, 718, 720. A deploy button 712 may be selected to prompt the deployment sub-tool to deploy a selected cloud environment.

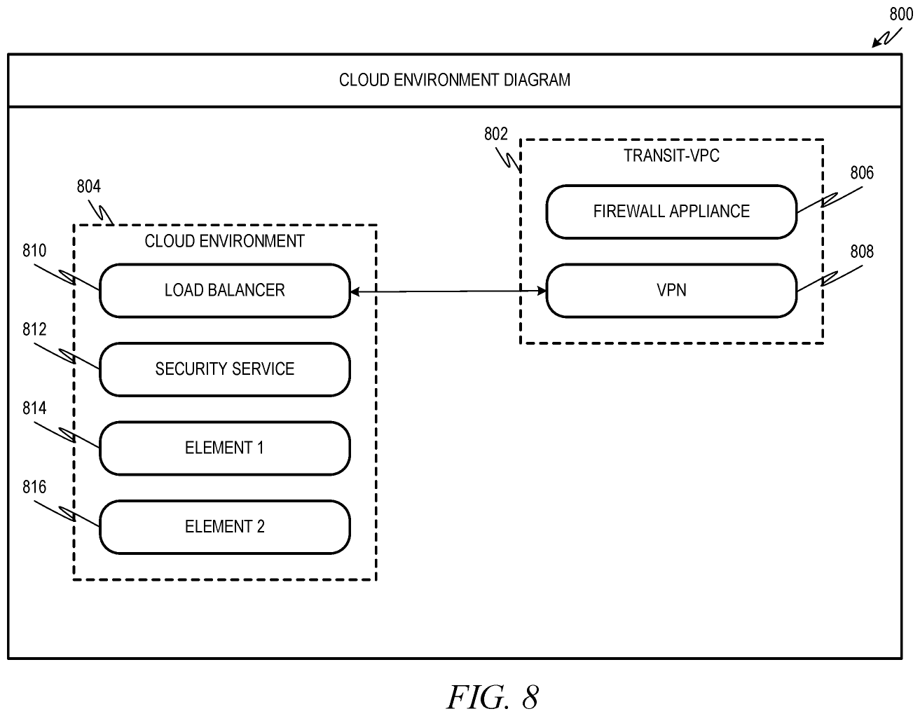

FIG. 8 shows an example diagram 800 of a cloud environment 804. The diagram 800 may be generated by the security concept sub-tool, for example, from cloud environment description data and may be included in a security concept document. The cloud environment 804 includes example elements including a load balancer 810, security service 812, and other cloud environment elements 814, 816. The diagram 800 also shows a connection between the load balancer 810 and a transit cloud environment 802 that may be deployed at the same cloud hyperscaler as the cloud environment 804. The transit cloud environment 802 may include a firewall appliance element 806 and a virtual private network (VPN) 808. For example, a security guideline may require that the cloud environment 804 communicate with the Internet or another wide area network via the transit cloud environment 802.

In view of the disclosure above, various examples are set forth below. It should be noted that one or more features of an example, taken in isolation or combination, should be considered within the disclosure of this application.

### Examples

Example 1 is a system for securely deploying a cloud environment to a cloud hyperscaler infrastructure, the system comprising: at least one processor programmed to perform operations comprising: receiving from a first user a description of a first cloud environment element to be included in a first cloud environment, the description being received via a web application executing at a first user computing device associated with the first user; determining that the description of the first cloud environment element is consistent with cloud environment security guideline data; adding the first cloud environment element to first cloud environment description data describing the first cloud environment; generating a first security concept document for the first cloud environment, the first security concept document comprising a text description of the first cloud environment including the first cloud environment element; receiving, from the first user, an instruction to create the first cloud environment; generating first deployment code, the first deployment code comprising executable code describing the first cloud environment, the executable code describing the first cloud environment being consistent with the first security concept document; and submitting the first deployment code to create the first cloud environment at the cloud hyperscaler infrastructure.

In Example 2, the subject matter of Example 1 optionally includes the operations further comprising determining that the first security concept document is approved for deployment.

In Example 3, the subject matter of any one or more of Examples 1-2 optionally includes the operations further comprising: publishing a first deploy message comprising the first deployment code to a deployment queue; and receiving, from the cloud hyperscaler infrastructure, a first success message indicating that the first cloud environment has been created at the cloud hyperscaler infrastructure.

In Example 4, the subject matter of any one or more of Examples 1-3 optionally includes the operations further comprising: receiving, from the first user, a description of a second cloud environment element to be included in the first cloud environment; determining that the description of the second cloud environment element is not consistent with the cloud environment security guideline data; and displaying, to the first user, a rejection message indicating that the second cloud environment element is not to be added to the first cloud environment description data.

In Example 5, the subject matter of any one or more of Examples 1-4 optionally includes the operations further comprising: storing the first security concept document to a working database; and storing, at the working database, first association data associating the first security concept document to a first workspace comprising a plurality of workspace users.

In Example 6, the subject matter of Example 5 optionally includes the operations further comprising: before receiving the instruction to create the first cloud environment, receiving from a second user of the plurality of workspace users a modification to the first cloud environment; and modifying the first security concept document to reflect the modification.

In Example 7, the subject matter of any one or more of Examples 1-6 optionally includes the operations further comprising generating a first cloud environment diagram, the first cloud environment diagram comprising a graphical representation of the first cloud environment element, a graphical representation of an additional cloud environment element, and a graphical indicator of a relationship between the first cloud environment element and the additional cloud environment element, the first security concept document comprising the first cloud environment diagram.

In Example 8, the subject matter of any one or more of Examples 1-7 optionally includes the operations further comprising accessing a default cloud environment description data, wherein the adding of the first cloud environment element to the first cloud environment description data comprises adding an indication of the first cloud environment element to the default cloud environment description data.

In Example 9, the subject matter of Example 8 optionally includes the default cloud environment description data comprising a description of at least one default cloud environment element, the first cloud environment comprising the at least one default cloud environment element.

Example 10 is a method for securely deploying a cloud environment to a cloud hyperscaler infrastructure, the method comprising: receiving from a first user a description of a first cloud environment element to be included in a first cloud environment, the description being received via a web application executing at a first user computing device associated with the first user; determining that the description of the first cloud environment element is consistent with cloud environment security guideline data; adding the first cloud environment element to first cloud environment description data describing the first cloud environment; generating a first security concept document for the first cloud environment, the first security concept document comprising a text description of the first cloud environment including the first cloud environment element; receiving, from the first user, an instruction to create the first cloud environment; generating first deployment code, the first deployment code comprising executable code describing the first cloud environment, the executable code describing the first cloud environment being consistent with the first security concept document; and submitting the first deployment code to create the first cloud environment at the cloud hyperscaler infrastructure.

In Example 11, the subject matter of Example 10 optionally includes determining that the first security concept document is approved for deployment.

In Example 12, the subject matter of any one or more of Examples 10-11 optionally includes publishing a first deploy message comprising the first deployment code to a deployment queue; and receiving, from the cloud hyperscaler infrastructure, a first success message indicating that the first cloud environment has been created at the cloud hyperscaler infrastructure.

In Example 13, the subject matter of any one or more of Examples 10-12 optionally includes receiving, from the first user, a description of a second cloud environment element to be included in the first cloud environment; determining that the description of the second cloud environment element is not consistent with the cloud environment security guideline data; and displaying, to the first user, a rejection message indicating that the second cloud environment element is not to be added to the first cloud environment description data.

In Example 14, the subject matter of any one or more of Examples 10-13 optionally includes storing the first security concept document to a working database; and storing, at the working database, first association data associating the first security concept document to a first workspace comprising a plurality of workspace users.

In Example 15, the subject matter of Example 14 optionally includes before receiving the instruction to create the first cloud environment, receiving from a second user of the plurality of workspace users a modification to first cloud environment; and modifying the first security concept document to reflect the modification.

In Example 16, the subject matter of any one or more of Examples 10-15 optionally includes generating a first cloud environment diagram, the first cloud environment diagram comprising a graphical representation of the first cloud environment element, a graphical representation of an additional cloud environment element, and a graphical indicator of a relationship between the first cloud environment element and the additional cloud environment element, the first security concept document comprising the first cloud environment diagram.

In Example 17, the subject matter of any one or more of Examples 10-16 optionally includes accessing a default cloud environment description data, wherein the adding of the first cloud environment element to the first cloud environment description data comprises adding an indication of the first cloud environment element to the default cloud environment description data.

In Example 18, the subject matter of Example 17 optionally includes the default cloud environment description data comprising a description of at least one default cloud environment element, the first cloud environment comprising the at least one default cloud environment element.

Example 19 is a non-transitory machine-readable medium comprising instructions thereon that, when executed by at least one processor, causes the at least one processor to perform operations comprising: receiving from a first user a description of a first cloud environment element to be included in a first cloud environment, the description being received via a web application executing at a first user computing device associated with the first user; determining that the description of the first cloud environment element is consistent with cloud environment security guideline data; adding the first cloud environment element to first cloud environment description data describing the first cloud environment; generating a first security concept document for the first cloud environment, the first security concept document comprising a text description of the first cloud environment including the first cloud environment element; receiving, from the first user, an instruction to create the first cloud environment; generating first deployment code, the first deployment code comprising executable code describing the first cloud environment, the executable code describing the first cloud environment being consistent with the first security concept document; and submit the first deployment code to create the first cloud environment at a cloud hyperscaler infrastructure.

In Example 20, the subject matter of Example 19 optionally includes the operations further comprising determining that the first security concept document is approved for deployment.

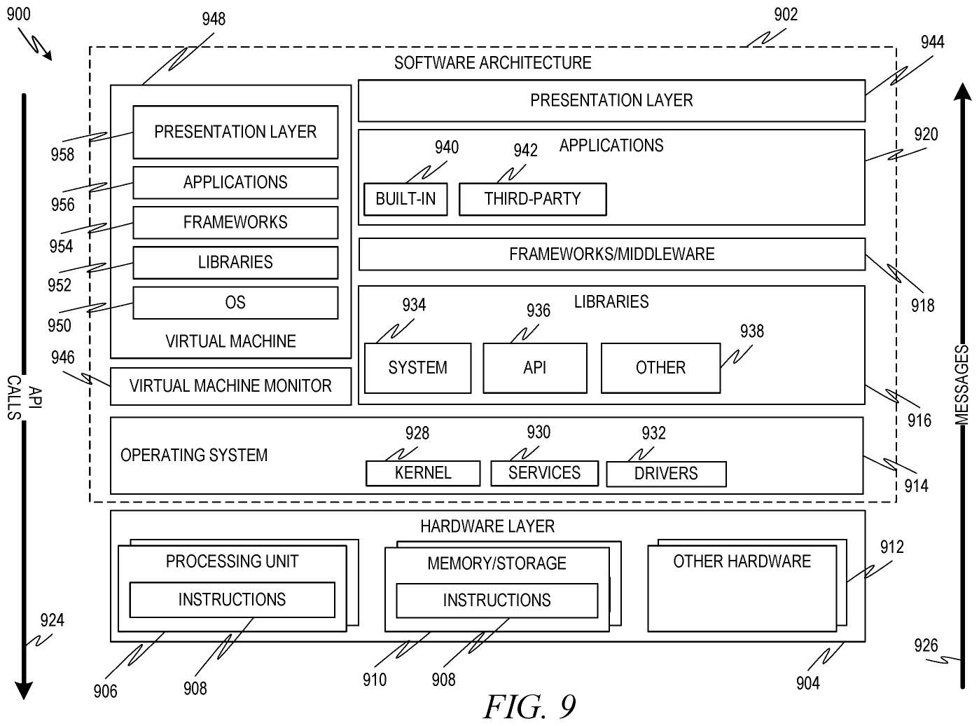

FIG. 9 is a block diagram 900 showing one example of a software architecture 902 for a computing device. The architecture 902 may be used in conjunction with various hardware architectures, for example, as described herein. FIG. 9 is merely a non-limiting example of a software architecture and many other architectures may be implemented to facilitate the functionality described herein. A representative hardware layer 904 is illustrated and can represent, for example, any of the above referenced computing devices. In some examples, the hardware layer 904 may be implemented according to the architecture of the computer system of FIG. 9.

The representative hardware layer 904 comprises one or more processing units 906 having associated executable instructions 908. Executable instructions 908 represent the executable instructions of the software architecture 902, including implementation of the methods, modules, subsystems, and components, and so forth described herein and may also include memory and/or storage modules 910, which also have executable instructions 908. Hardware layer 904 may also comprise other hardware as indicated by other hardware 912 which represents any other hardware of the hardware layer 904, such as the other hardware illustrated as part of the architecture 902.

In the example architecture of FIG. 9, the software architecture 902 may be conceptualized as a stack of layers where each layer provides particular functionality. For example, the software architecture 902 may include layers such as an operating system 914, libraries 916, frameworks/middleware 918, applications 920, and presentation layer 944. Operationally, the applications 920 and/or other components within the layers may invoke API calls 924 through the software stack and access a response, returned values, and so forth illustrated as messages 926 in response to the API calls 924. The layers illustrated are representative in nature and not all software architectures have all layers. For example, some mobile or special purpose operating systems may not provide a frameworks/middleware layer 918, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. In some examples, the services 930 include an interrupt service. The interrupt service may detect the receipt of an interrupt and, in response, cause the architecture 902 to pause its current processing and execute an interrupt service routine (ISR) when an interrupt is accessed.

The drivers 932 may be responsible for controlling or interfacing with the underlying hardware. For instance, the drivers 932 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 916 may provide a common infrastructure that may be utilized by the applications 920 and/or other components and/or layers. The libraries 916 typically provide functionality that allows other software modules to perform tasks in an easier fashion than to interface directly with the underlying operating system 914 functionality (e.g., kernel 928, services 930 and/or drivers 932). The libraries 916 may include system libraries 934 (e.g., C standard library) that may provide functions such as memory allocation functions, string manipulation functions, mathematic functions, and the like. In addition, the libraries 916 may include API libraries 936 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The frameworks 918 (also sometimes referred to as middleware) may provide a higher-level common infrastructure that may be utilized by the applications 920 and/or other software components/modules. For example, the frameworks 918 may provide various graphic user interface (GUI) functions, high-level resource management, high-level location services, and so forth. The frameworks 918 may provide a broad spectrum of other APIs that may be utilized by the applications 920 and/or other software components/modules, some of which may be specific to a particular operating system or platform.

The applications 920 includes built-in applications 940 and/or third-party applications 942. Examples of representative built-in applications 940 may include, but are not limited to, a contacts application, a browser application, a book reader application, a location application, a media application, a messaging application, and/or a game application. Third-party applications 942 may include any of the built-in applications 940 as well as a broad assortment of other applications. In a specific example, the third-party application 942 (e.g., an application developed using the Android™ or iOS™ software development kit (SDK) by an entity other than the vendor of the particular platform) may be mobile software running on a mobile operating system such as iOS™ Android™, Windows® Phone, or other mobile computing device operating systems. In this example, the third-party application 942 may invoke the API calls 924 provided by the mobile operating system such as operating system 914 to facilitate functionality described herein.

The applications 920 may utilize built-in operating system functions (e.g., kernel 928, services 930 and/or drivers 932), libraries (e.g., system libraries 934, API libraries 936, and other libraries 938), and frameworks/middleware 918 to create user interfaces to interact with users of the system. Alternatively, or additionally, in some systems interactions with a user may occur through a presentation layer, such as presentation layer 944. In these systems, the application/module “logic” can be separated from the aspects of the application/module that interact with a user.

Some software architectures utilize virtual machines. In the example of FIG. 9, this is illustrated by virtual machine 948. A virtual machine creates a software environment where applications/modules can execute as if they were executing on a hardware computing device. A virtual machine is hosted by a host operating system (operating system 914) and typically, although not always, has a virtual machine monitor 946, which manages the operation of the virtual machine 948 as well as the interface with the host operating system (i.e., operating system 914). A software architecture executes within the virtual machine 948 such as an operating system 950, libraries 952, frameworks/middleware 954, applications 956 and/or presentation layer 958. These layers of software architecture executing within the virtual machine 948 can be the same as corresponding layers previously described or may be different.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

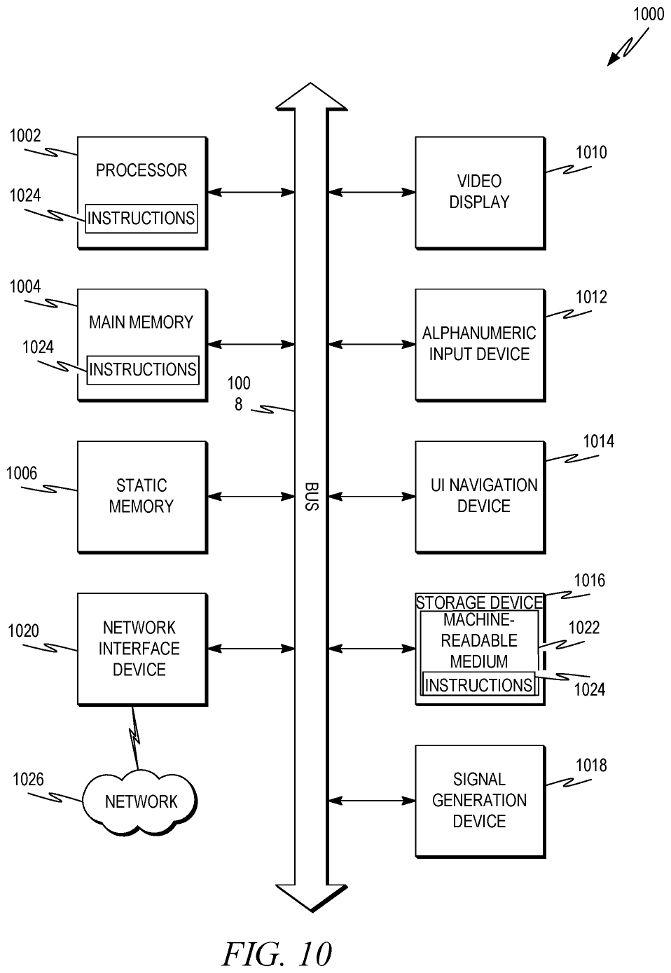

FIG. 10 is a block diagram of a machine in the example form of a computer system 1000 within which instructions 1024 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU), or both), a main memory 1004, and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard or a touch-sensitive display screen), a user interface (UI) navigation (or cursor control) device 1014 (e.g., a mouse), a disk drive unit 1016, a signal generation device 1018 (e.g., a speaker), and a network interface device 1020.

### Machine-Readable Medium

The disk drive unit 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, with the main memory 1004 and the processor 1002 also constituting machine-readable media 1022.

While the machine-readable medium 1022 is shown in an example embodiment to be a single medium, the term “machine-readable medium” may include a single medium or multiple media (e.g., a centralized or distributed database, and/or associated caches and servers) that store the one or more instructions 1024 or data structures. The term “machine-readable medium” shall also be taken to include any tangible medium that is capable of storing, encoding, or carrying instructions 1024 for execution by the machine and that cause the machine to perform any one or more of the methodologies of the present disclosure, or that is capable of storing, encoding, or carrying data structures utilized by or associated with such instructions 1024. The term “machine-readable medium” shall accordingly be taken to include, but not be limited to, solid-state memories, and optical and magnetic media. Specific examples of machine-readable media 1022 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1024 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system for securely deploying a cloud environment to a cloud hyperscaler infrastructure, the system comprising:
at least one processor programmed to perform operations comprising:
receiving from a first user a description of a first cloud environment element to be included in a first cloud environment, the description being received via a web application executing at a first user computing device associated with the first user;
determining that the description of the first cloud environment element is consistent with cloud environment security guideline data;
adding the first cloud environment element to first cloud environment description data describing the first cloud environment;
generating a first security concept document for the first cloud environment, the first security concept document comprising a text description of the first cloud environment including the first cloud environment element;
receiving, from the first user, an instruction to create the first cloud environment;
generating first deployment code, the first deployment code comprising executable code describing the first cloud environment, the executable code describing the first cloud environment being consistent with the first security concept document; and
submitting the first deployment code to create the first cloud environment at the cloud hyperscaler infrastructure.

2. The system of claim 1, the operations further comprising determining that the first security concept document is approved for deployment.

3. The system of claim 1, the operations further comprising:
publishing a first deploy message comprising the first deployment code to a deployment queue; and
receiving, from the cloud hyperscaler infrastructure, a first success message indicating that the first cloud environment has been created at the cloud hyperscaler infrastructure.

4. The system of claim 1, the operations further comprising:
receiving, from the first user, a description of a second cloud environment element to be included in the first cloud environment;
determining that the description of the second cloud environment element is not consistent with the cloud environment security guideline data; and
displaying, to the first user, a rejection message indicating that the second cloud environment element is not to be added to the first cloud environment description data.

5. The system of claim 1, the operations further comprising:
storing the first security concept document to a working database; and
storing, at the working database, first association data associating the first security concept document to a first workspace comprising a plurality of workspace users.

6. The system of claim 5, the operations further comprising:
before receiving the instruction to create the first cloud environment, receiving from a second user of the plurality of workspace users a modification to the first cloud environment; and
modifying the first security concept document to reflect the modification.

7. The system of claim 1, the operations further comprising generating a first cloud environment diagram, the first cloud environment diagram comprising a graphical representation of the first cloud environment element, a graphical representation of an additional cloud environment element, and a graphical indicator of a relationship between the first cloud environment element and the additional cloud environment element, the first security concept document comprising the first cloud environment diagram.

8. The system of claim 1, the operations further comprising accessing a default cloud environment description data, wherein the adding of the first cloud environment element to the first cloud environment description data comprises adding an indication of the first cloud environment element to the default cloud environment description data.

9. The system of claim 8, the default cloud environment description data comprising a description of at least one default cloud environment element, the first cloud environment comprising the at least one default cloud environment element.

10. A method for securely deploying a cloud environment to a cloud hyperscaler infrastructure, the method comprising:
receiving from a first user a description of a first cloud environment element to be included in a first cloud environment, the description being received via a web application executing at a first user computing device associated with the first user;
determining that the description of the first cloud environment element is consistent with cloud environment security guideline data;
adding the first cloud environment element to first cloud environment description data describing the first cloud environment;
generating a first security concept document for the first cloud environment, the first security concept document comprising a text description of the first cloud environment including the first cloud environment element;
receiving, from the first user, an instruction to create the first cloud environment;
generating first deployment code, the first deployment code comprising executable code describing the first cloud environment, the executable code describing the first cloud environment being consistent with the first security concept document; and
submitting the first deployment code to create the first cloud environment at the cloud hyperscaler infrastructure.

11. The method of claim 10, further comprising determining that the first security concept document is approved for deployment.

12. The method of claim 10, further comprising:
publishing a first deploy message comprising the first deployment code to a deployment queue; and
receiving, from the cloud hyperscaler infrastructure, a first success message indicating that the first cloud environment has been created at the cloud hyperscaler infrastructure.

13. The method of claim 10, further comprising:
receiving, from the first user, a description of a second cloud environment element to be included in the first cloud environment;
determining that the description of the second cloud environment element is not consistent with the cloud environment security guideline data; and
displaying, to the first user, a rejection message indicating that the second cloud environment element is not to be added to the first cloud environment description data.

14. The method of claim 10, further comprising:
storing the first security concept document to a working database; and
storing, at the working database, first association data associating the first security concept document to a first workspace comprising a plurality of workspace users.

15. The method of claim 14, further comprising:
before receiving the instruction to create the first cloud environment, receiving from a second user of the plurality of workspace users a modification to first cloud environment; and
modifying the first security concept document to reflect the modification.

16. The method of claim 10, further comprising generating a first cloud environment diagram, the first cloud environment diagram comprising a graphical representation of the first cloud environment element, a graphical representation of an additional cloud environment element, and a graphical indicator of a relationship between the first cloud environment element and the additional cloud environment element, the first security concept document comprising the first cloud environment diagram.

17. The method of claim 10, further comprising accessing a default cloud environment description data, wherein the adding of the first cloud environment element to the first cloud environment description data comprises adding an indication of the first cloud environment element to the default cloud environment description data.

18. The method of claim 17, the default cloud environment description data comprising a description of at least one default cloud environment element, the first cloud environment comprising the at least one default cloud environment element.

19. A non-transitory machine-readable medium comprising instructions thereon that, when executed by at least one processor, causes the at least one processor to perform operations comprising:
receiving from a first user a description of a first cloud environment element to be included in a first cloud environment, the description being received via a web application executing at a first user computing device associated with the first user;
determining that the description of the first cloud environment element is consistent with cloud environment security guideline data;
adding the first cloud environment element to first cloud environment description data describing the first cloud environment;
generating a first security concept document for the first cloud environment, the first security concept document comprising a text description of the first cloud environment including the first cloud environment element;
receiving, from the first user, an instruction to create the first cloud environment;
generating first deployment code, the first deployment code comprising executable code describing the first cloud environment, the executable code describing the first cloud environment being consistent with the first security concept document; and
submit the first deployment code to create the first cloud environment at a cloud hyperscaler infrastructure.

20. The medium of claim 19, the operations further comprising determining that the first security concept document is approved for deployment.
